(19) United States
(12) Patent Application Publication
(10) Pub. No.: US 2026/0223979 A1
(43) Pub. Date: Aug. 6, 2026

(54) DYNAMIC WATERPROOF AND BREATHABLE SHOE SOLE, SHOE, AND METHOD FOR MANUFACTURING THE SAME

(71) Applicant: KUANRONG ZHANG, Mississauga (CA)

(72) Inventor: KUANRONG ZHANG, Mississauga (CA)

(21) Appl. No.: 19/636,894

(22) Filed: Apr. 1, 2026

(30) Foreign Application Priority Data
Jan. 6, 2026 (CN) 202620008782.1

(51) Int. Cl. A43B 7/10; A43B 7/08; A43B 7/12; A43B 13/12; B29D 35/12; B29K 75/00; B29K 105/04

(52) U.S. Cl. CPC A43B 7/10; A43B 7/087; A43B 7/12; A43B 13/12; B29D 35/122; B29K 2075/00; B29K 2105/046

(57) ABSTRACT

A dynamic waterproof and breathable shoe sole, shoe, and manufacturing method are disclosed. The shoe sole includes a sole body having a flow-guiding channel system including a flow-guiding channel, a dynamic sealing column, a recessed groove structure, and an end cap structure. The end cap structure is made of supercritical-foamed thermoplastic elastomer. A sealing head at a bottom of the dynamic sealing column is coated with a thermoplastic elastomer layer and engages an annular sealing member at a bottom of the flow-guiding channel. The invention enables millisecond-level intelligent switching between waterproofing and ventilation during walking and provides a dynamic pumping moisture-discharge effect.

### CROSS-REFERENCE TO RELATED APPLICATIONS

This application claims priority to Chinese Patent Application No. 202620008782.1, filed on Jan. 6, 2026, which is hereby incorporated by reference in its entirety.

### TECHNICAL FIELD

The present invention relates to the technical field of footwear products, and more particularly to a shoe sole having a dynamic waterproof and breathable function, a shoe comprising the shoe sole, and a method for manufacturing the shoe sole.

### BACKGROUND

Footwear that simultaneously provides waterproof and breathable functions is an important requirement in fields such as outdoor sports and daily commuting. Various technical solutions have been proposed in the prior art to address this issue, but most of them present certain limitations.

For example, certain prior art solutions employ specially shaped breathable through-holes in the outsole, utilizing fluid pressure variations in variable cross-section channels to prevent external water flow from rising into the shoe interior while allowing water vapor to be discharged. The waterproof function of this solution relies on the fixed geometric shape of the channel and therefore represents a static and continuous water-blocking design. A potential technical problem of this approach is that, under prolonged water immersion conditions, water pressure may overcome the resistance of the channel. In addition, the complex internal diversion groove structure may increase manufacturing difficulty, and the static waterproof structure may somewhat affect optimal ventilation efficiency when the footwear is not exposed to water.

Another technical route adopts a layered structure composed of a waterproof breathable membrane, such as an expanded polytetrafluoroethylene (ePTFE) membrane, and a supporting mesh. However, this type of solution also presents several technical issues:
(1) waterproof breathable membranes are relatively costly and have limited physical strength, and may fail if punctured or abraded by foreign objects;
(2) the breathable performance of the membrane has an upper limit, and the interior of the shoe may still feel stuffy during high-intensity activities that produce large amounts of perspiration; and
(3) the manufacturing process is relatively complex, requiring precise sealing and bonding processes to prevent peripheral water leakage.

A further approach utilizes spiral grooves for gas-water separation, where water is retained at the outer region of the groove by means of a long flow path and centrifugal force, while gas enters a central ventilation hole. Although the structure of this solution is relatively simple, its waterproof performance largely depends on the geometric dimensions and length of the grooves. When high-speed water impact occurs during intense movement, the separation effect may decrease. Meanwhile, the relatively long ventilation path may reduce air exchange efficiency.

In summary, waterproof and breathable shoe soles in the prior art generally rely on one of the following approaches: static fluid-mechanics-based designs using specific hole shapes, functional membrane materials, or long-path separation structures. These approaches share a common challenge in that they are difficult to intelligently and adaptively adjust according to the actual usage state of the wearer, such as standing still, walking, or wading in water, in order to achieve an optimal dynamic balance between waterproofing and ventilation, where efficient sealing is provided when waterproofing is required and airflow remains unobstructed when ventilation is needed. Most existing solutions merely achieve a fixed compromise between breathability and waterproofing, rather than providing a dynamically optimized solution.

### SUMMARY

The present invention aims to address the technical problems in the prior art in which the waterproof and breathable functions of a shoe sole cannot be dynamically balanced and typically rely on expensive materials or complex static structures. The invention provides a shoe sole capable of achieving millisecond-level intelligent switching between waterproofing and ventilation according to the gait of a wearer, while also providing efficient dynamic moisture discharge capability, as well as a method for manufacturing the shoe sole.

To achieve the above objective, the present invention adopts the following technical solutions.

A dynamic waterproof and breathable shoe sole is provided, comprising a sole body.

At least one flow-guiding channel system is provided within the sole body.

The flow-guiding channel system comprises a flow-guiding channel and a dynamic sealing column.

The flow-guiding channel has a first port communicating with an interior space of the shoe and a second port communicating with an external environment.

The dynamic sealing column is movably disposed within the flow-guiding channel.

The dynamic sealing column has a first state and a second state. In the first state, a breathable gap exists between the dynamic sealing column and a wall surface of the flow-guiding channel. In the second state, the dynamic sealing column forms a sealing engagement with the wall surface of the flow-guiding channel in response to external pressure so as to block passage of liquid.

Further, the flow-guiding channel system further comprises a recessed groove structure disposed on a surface inside the shoe that contacts the user's foot. The recessed groove structure is a concave structure. An end cap structure is arranged within the recessed groove structure, and the end cap structure seals the first port. A central portion of the end cap structure is fixedly connected to an upper portion of the dynamic sealing column. The end cap structure is provided with a plurality of water-guiding and air-guiding holes distributed around the periphery of the dynamic sealing column. Each water-guiding and air-guiding hole communicates with a space below the first port.

Further, the end cap structure is made of a highly elastic lightweight material and remains substantially flat or slightly convex under normal conditions, thereby suspending the dynamic sealing column in a middle-upper portion of the flow-guiding channel. When vertical pressure from the user's foot is applied, the end cap structure undergoes elastic deformation and moves downward, thereby driving the dynamic sealing column to move downward accordingly.

Further, a sealing head is formed at a bottom portion of the dynamic sealing column. A sealing valve seat is correspondingly provided at a bottom or side wall of the flow-guiding channel. In the second state, the sealing head is pressed against the sealing valve seat under pressure to form a sealing engagement.

Further, a water-guiding and air-permeable groove is further provided inside the shoe. The water-guiding and air-permeable groove forms a network-like intersecting distribution structure on the inner sole plane of the shoe and communicates with at least one recessed groove structure so that moisture within different regions of the shoe can be collected and guided into the flow-guiding channel system.

Further, the sole body comprises an upper elastic midsole layer and a lower wear-resistant outsole layer. The recessed groove structure and the water-guiding and air-permeable groove are formed on an upper surface of or within the elastic midsole layer. The flow-guiding channel is formed within the wear-resistant outsole layer. A plurality of funnel structures are further provided on a ground-contacting surface of the wear-resistant outsole layer, and a bottom of each funnel structure corresponds to and communicates with the second port of one flow-guiding channel.

In summary, the present invention provides a dynamic waterproof and breathable shoe sole including a composite sole body comprising an upper elastic midsole layer and a lower wear-resistant outsole layer. The elastic midsole layer and the wear-resistant outsole layer are bonded by adhesive bonding or hot-press lamination.

At least one flow-guiding channel system is arranged within the sole body.

The flow-guiding channel system includes:
a flow-guiding channel formed in the wear-resistant outsole layer and having a first port communicating with the interior of the shoe and a second port communicating with the external environment;
a dynamic sealing column movably disposed within the flow-guiding channel;
a recessed groove structure disposed on the upper surface of the elastic midsole layer and forming a concave structure; and
an end cap structure disposed within the recessed groove structure and sealing the first port, a central portion of the end cap structure being fixedly connected to an upper portion of the dynamic sealing column.

The dynamic sealing column has a first state and a second state. In the first state, a breathable gap exists between the dynamic sealing column and the wall surface of the flow-guiding channel. In the second state, the dynamic sealing column moves downward in response to external pressure and forms a sealing engagement with the wall surface of the flow-guiding channel so as to block liquid.

The end cap structure is made of a supercritical-fluid-foamed thermoplastic polyurethane elastomer or thermoplastic polyester elastomer having the following characteristics:
the foaming ratio ranges from 1.8 to 2.5;
the closed-cell rate is greater than 90 percent;
the Shore C hardness ranges from 30 to 45;
the rebound resilience is greater than 62 percent according to ISO 8307; and
the compression set is less than 25 percent according to GB/T 6669 under conditions of 25 percent compression for 22 hours at 23 degrees Celsius.

The dynamic sealing column is made of thermoplastic polyurethane or nylon and has a Shore D hardness ranging from 55 to 65, the hardness being greater than that of the end cap structure.

A sealing head is formed at the bottom of the dynamic sealing column. A thermoplastic elastomer layer having a Shore A hardness of 65 to 75 is formed on a surface of the sealing head by secondary injection molding.

A sealing valve seat is provided at the bottom of the flow-guiding channel, and an annular sealing member is embedded within the sealing valve seat. The annular sealing member is made of a thermoplastic elastomer identical to or compatible with the thermoplastic elastomer coating layer of the sealing head.

The flow-guiding channel has a first inner diameter D1 and the dynamic sealing column has a second outer diameter D2. A difference between D1 and D2 ranges from 0.15 mm to 0.35 mm to form the breathable gap.

An elastic modulus E of the end cap structure and a depth H of the recessed groove structure satisfy the following relationship

E×H≥k×m×g
where E represents the elastic modulus of the end cap structure in MPa, H represents the depth of the recessed groove structure in millimeters, m represents the mass of the dynamic sealing column in grams, g represents gravitational acceleration of 9.8 meters per second squared, and k is a safety factor ranging from 3.0 to 4.5, so as to ensure that the dynamic sealing column can reliably return to the first state under a no-load condition.

The shoe interior further includes water-guiding and air-permeable grooves forming a network-like intersecting distribution structure on the inner sole surface. The grooves have a depth of 1.0 to 2.5 millimeters and a width of 1.5 to 3.0 millimeters and communicate with at least one recessed groove structure.

The ground-contacting surface of the wear-resistant outsole layer further includes a plurality of funnel structures. A bottom of each funnel structure corresponds to and communicates with the second port of one flow-guiding channel, and each funnel structure has an opening angle ranging from 60 degrees to 120 degrees.

In another aspect, the present invention provides a shoe comprising the dynamic waterproof and breathable shoe sole described above.

In another aspect, the present invention further provides a method for manufacturing the dynamic waterproof and breathable shoe sole, the method comprising the following steps.

Step S1: preparing the elastic midsole layer using a supercritical-fluid foaming process

Thermoplastic polyurethane elastomer particles are placed into a foaming mold. After the mold is sealed, supercritical carbon dioxide is injected as a physical foaming agent. The saturation temperature ranges from 160 to 185° C., the saturation pressure ranges from 12 to 25 MPa, and the saturation time ranges from 20 to 40 minutes. The pressure is then rapidly released to atmospheric pressure at a depressurization rate of 8 to 15 MPa/s to obtain a foamed sheet having a microcellular closed-cell structure. The foamed sheet is then placed in a cutting mold and cut to form the elastic midsole layer provided with the recessed groove structures and the water-guiding and air-permeable grooves.

Step S2: preparing the wear-resistant outsole layer and the sealing assembly using a two-shot injection molding process.

The temperature of a first injection unit is set to 210 to 230° C., and a wear-resistant thermoplastic material, such as wear-resistant TPU or a rubber-modified material, is injected into an outsole mold so as to simultaneously form the flow-guiding channels, the sealing valve seats, and the funnel structures. After the mold is opened, a prefabricated annular sealing member is inserted into the sealing valve seat by a robotic manipulator. The mold is then closed, and the temperature of a second injection unit is set to 190 to 210° C. A thermoplastic elastomer material is injected so as to form an integrated bonding structure with the annular sealing member at the sealing valve seat.

Step S3: preparing a pre-assembled component including the dynamic sealing column and the end cap structure.

A secondary injection molding process is adopted. First, the main body of the dynamic sealing column is injection molded using rigid TPU or nylon as the material, with an injection temperature of 220 to 240° C. The molded dynamic sealing column body is then placed into an end-cap mold, where a thermoplastic elastomer layer is overmolded on the surface of the sealing head. At the same time, the end cap structure is integrally formed at a top portion of the dynamic sealing column. The end cap structure is made of supercritical-foaming-grade TPU and is molded at an injection temperature of 190 to 210° C. to form the pre-assembled component.

Step S4: assembly.

The pre-assembled component obtained in Step S3 is installed into the recessed groove structure of the elastic midsole layer. A waterproof adhesive is applied along an edge of the end cap structure so that the end cap structure is sealingly fixed to an inner wall of the recessed groove structure, and the dynamic sealing column is inserted into the flow-guiding channel.

Step S5: lamination.

The elastic midsole layer assembled in Step S4 and the wear-resistant outsole layer prepared in Step S2 are bonded together by a hot-press lamination process. The hot-press temperature ranges from 80 to 100° C., the pressure ranges from 0.3 to 0.6 MPa, and the pressure-holding time ranges from 30 to 60 seconds, thereby completing preparation of the shoe sole.

Compared with the prior art, the present invention has the following significant advantages.

First, dynamic intelligent switching. By suspending the dynamic sealing column through the elastic end cap structure, millisecond-level switching between waterproofing and ventilation is achieved during walking. Experimental results show that under simulated walking conditions with a step frequency of sixty steps per minute, the response delay time of the shoe sole of the present invention is less than fifty milliseconds, which is significantly better than that of existing technologies.

Second, coordinated optimization of materials and structure. By defining the foaming ratio, closed-cell rate, hardness, and rebound resilience of the end cap material and combining a soft-hard composite structure of the sealing head, reliable sealing performance is achieved while maintaining stable performance after more than one hundred thousand dynamic cycles.

Third, dynamic pumping moisture discharge effect. During walking, reciprocating movement of the dynamic sealing column generates periodic negative pressure within the shoe, thereby actively extracting moisture from the shoe interior. Tests show that after two hours of continuous exercise, the internal humidity of shoes equipped with the present shoe sole is reduced by 35 to 42 percent compared with ordinary sports shoes and by 28 to 33 percent compared with static waterproof breathable shoes.

Fourth, dual safety protection. Mechanical sealing combined with air-chamber buffering provides dual protection. In dynamic waterproof testing of a complete shoe, continuous walking for one hour in water with a depth of ten centimeters results in water ingress of less than three grams, which is superior to the industry standard of five grams or less.

Fifth, controllable cost. The invention does not require expensive waterproof breathable membranes and instead uses conventional polymer materials and mature molding processes. The material cost is more than sixty percent lower than that of ePTFE-based solutions, and the manufacturing yield rate can reach more than ninety-five percent.

### BRIEF DESCRIPTION OF THE DRAWINGS

FIG. 1 is a schematic structural diagram of a dynamic waterproof and breathable shoe sole according to the present invention.

FIG. 2 is a schematic structural diagram showing an overall ventilation state of the dynamic waterproof and breathable shoe sole according to the present invention.

FIG. 3 is a schematic structural diagram showing an overall sealing state of the dynamic waterproof and breathable shoe sole according to the present invention.

FIG. 4 is a schematic structural diagram showing a ventilation state of a forefoot portion of the dynamic waterproof and breathable shoe sole according to the present invention.

FIG. 5 is a schematic structural diagram showing a ventilation state of a heel portion of the dynamic waterproof and breathable shoe sole according to the present invention.

FIG. 6 is a cross-sectional schematic view of a side portion of the dynamic waterproof and breathable shoe sole according to the present invention.

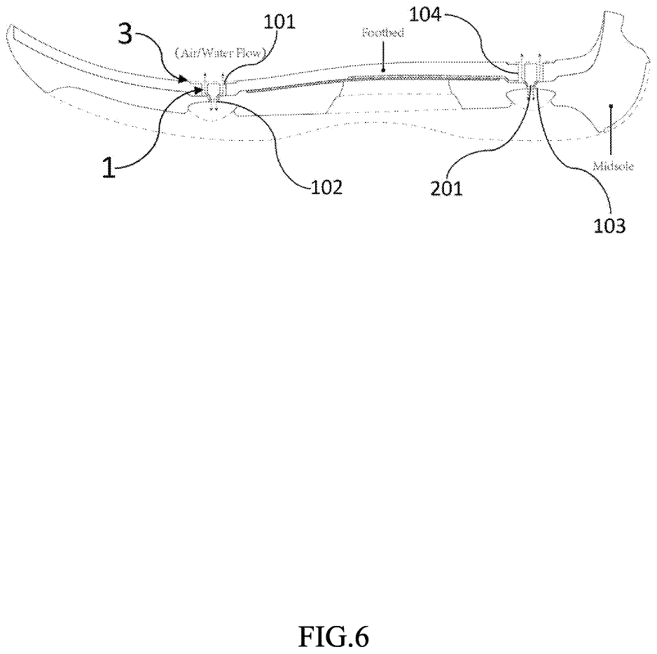

FIG. 7 is a cross-sectional schematic view of a partial structure of the dynamic waterproof and breathable shoe sole according to the present invention.

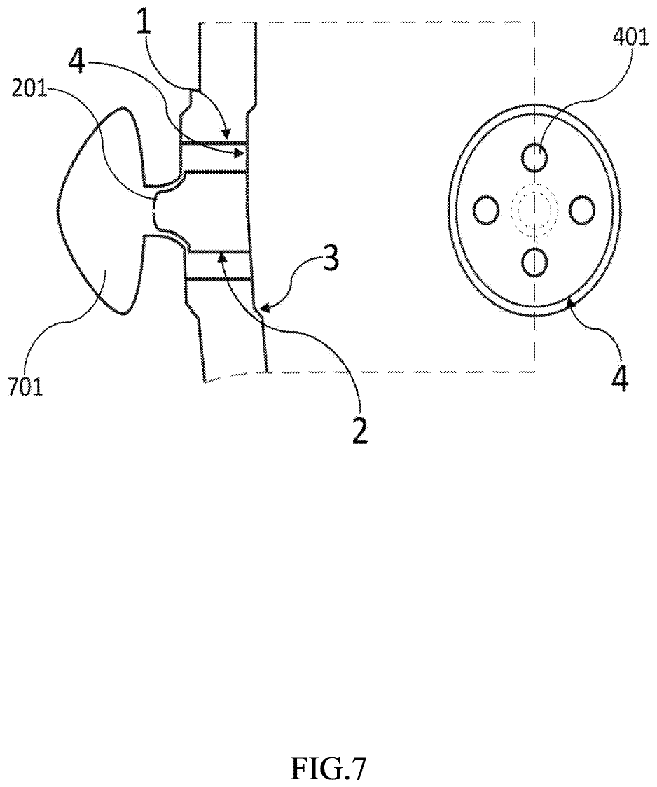

FIG. 8 is a schematic structural diagram showing the dynamic waterproof and breathable shoe sole according to the present invention from another direction.

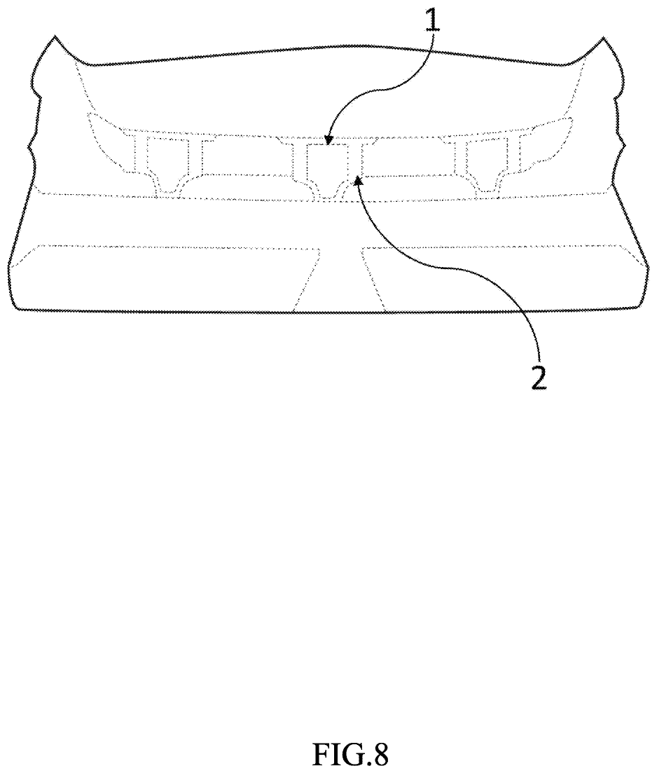

FIG. 9 is a schematic structural diagram showing the dynamic waterproof and breathable shoe sole according to the present invention from another direction.

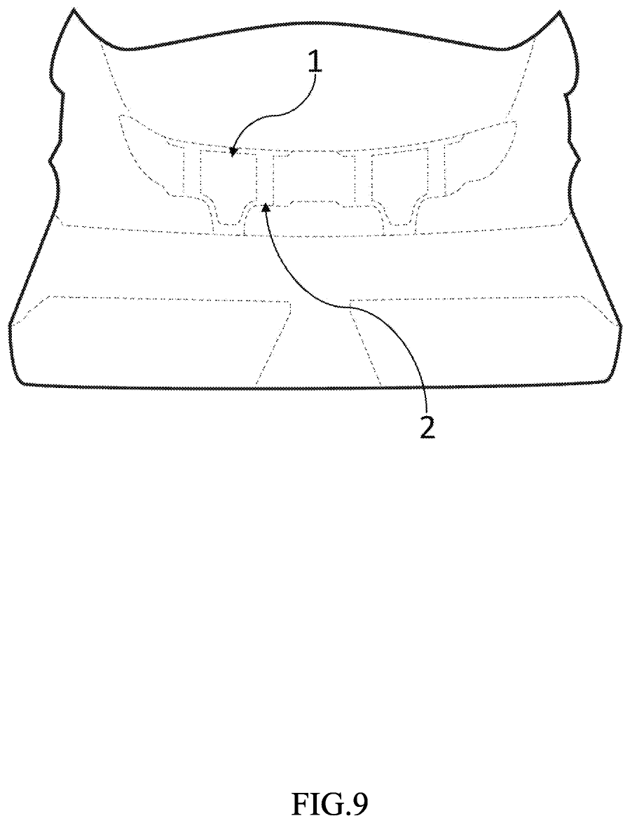

### DESCRIPTION OF EMBODIMENTS

In order to make the objectives, features, and advantages of the present invention more clearly understood, specific embodiments of the present invention are described in detail below with reference to the accompanying drawings. Numerous specific details are set forth in the following description to facilitate a full understanding of the present invention. However, the present invention may be implemented in many other forms different from those described herein. Those skilled in the art may make similar improvements without departing from the spirit and scope of the present invention. Accordingly, the present invention is not limited to the specific embodiments disclosed below.

In the description of the present invention, it should be understood that terms such as “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” and “circumferential” indicate orientations or positional relationships based on the orientations or positional relationships shown in the drawings. These terms are used only for convenience in describing the present invention and for simplifying the description, and do not indicate or imply that the referenced device or element must have a particular orientation or must be constructed and operated in a particular orientation. Therefore, these terms should not be interpreted as limiting the present invention.

Furthermore, the terms “first” and “second” are used merely for descriptive purposes and should not be interpreted as indicating or implying relative importance or implicitly indicating the number of the indicated technical features. Accordingly, a feature defined as “first” or “second” may explicitly or implicitly include one or more such features. In the description of the present invention, the term “plurality” means at least two unless otherwise specifically defined.

In the present invention, unless otherwise expressly specified or limited, terms such as “mounted,” “connected,” “coupled,” and “fixed” should be understood in a broad sense. For example, the connection may be a fixed connection, a detachable connection, or an integral connection. The connection may be a mechanical connection or an electrical connection. The connection may be a direct connection or an indirect connection through an intermediate medium. The connection may also represent internal communication between two components or an interaction relationship between two components. Those skilled in the art can understand the specific meaning of these terms in the present invention according to specific circumstances.

In the present invention, unless otherwise clearly specified or limited, when a first feature is described as being “on” or “below” a second feature, the first feature may be in direct contact with the second feature, or may be indirectly in contact with the second feature through an intermediate component. Moreover, when a first feature is described as being “above,” “over,” or “on top of” a second feature, the first feature may be directly above or obliquely above the second feature, or may simply indicate that the first feature has a higher level than the second feature. Similarly, when a first feature is described as being “below,” “under,” or “beneath” a second feature, the first feature may be directly below or obliquely below the second feature, or may simply indicate that the first feature has a lower level than the second feature.

It should also be noted that when a component is described as being “fixed to” or “disposed on” another component, it may be directly on the other component or there may be an intermediate component. When a component is described as being “connected to” another component, it may be directly connected to the other component or there may be an intermediate component present at the same time. The terms “vertical,” “horizontal,” “upper,” “lower,” “left,” and “right” used herein are merely for convenience of description and do not represent the only possible orientations of the invention.

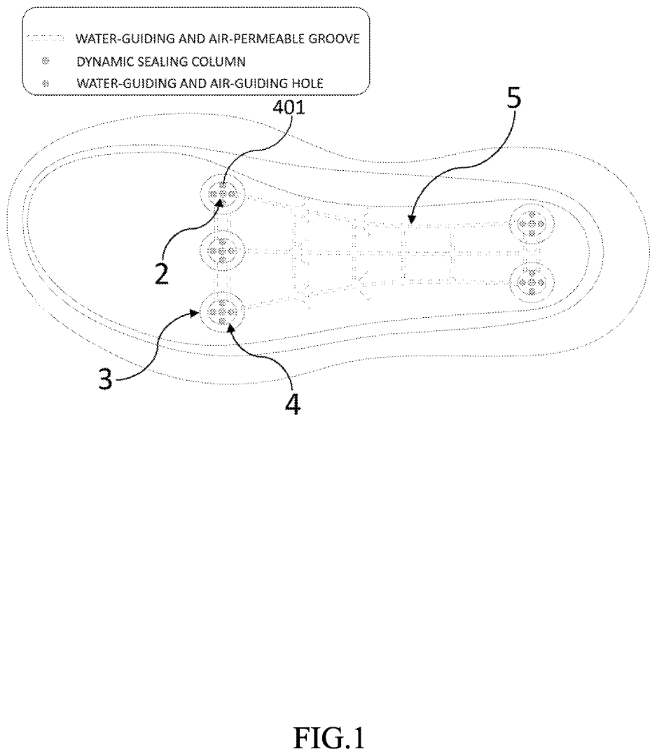

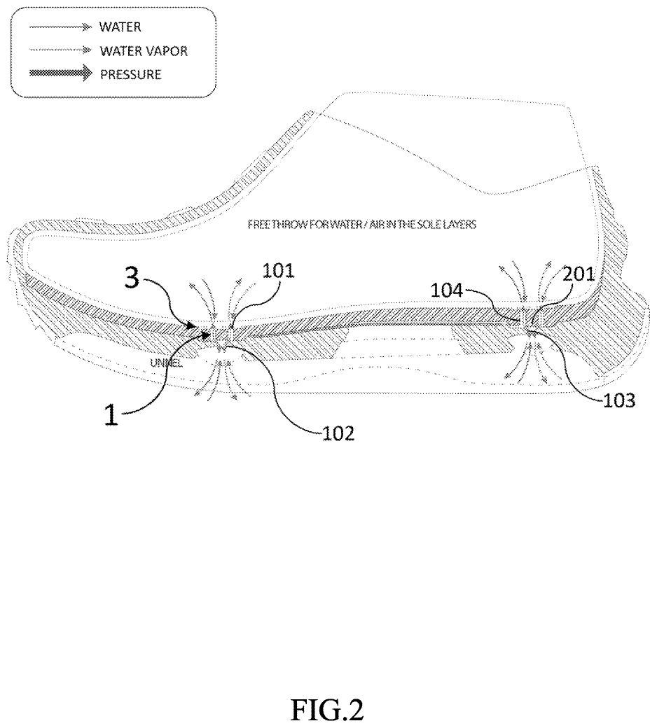

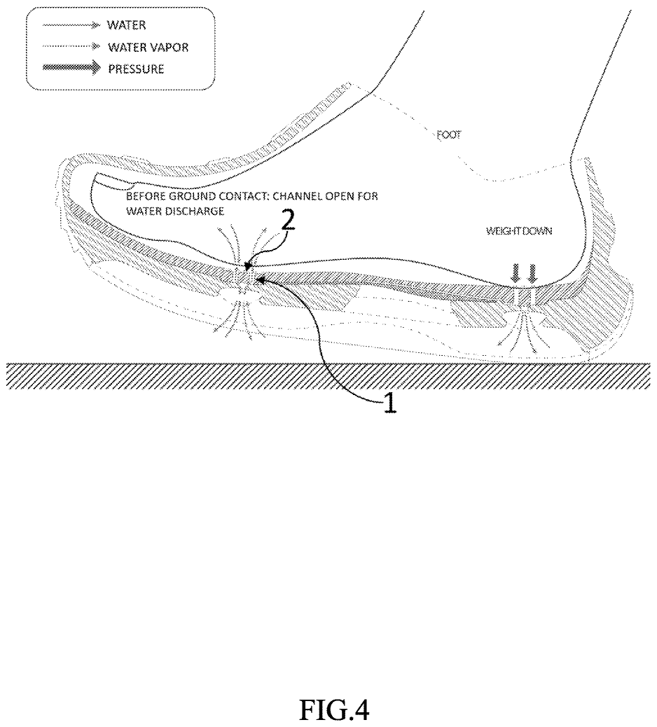

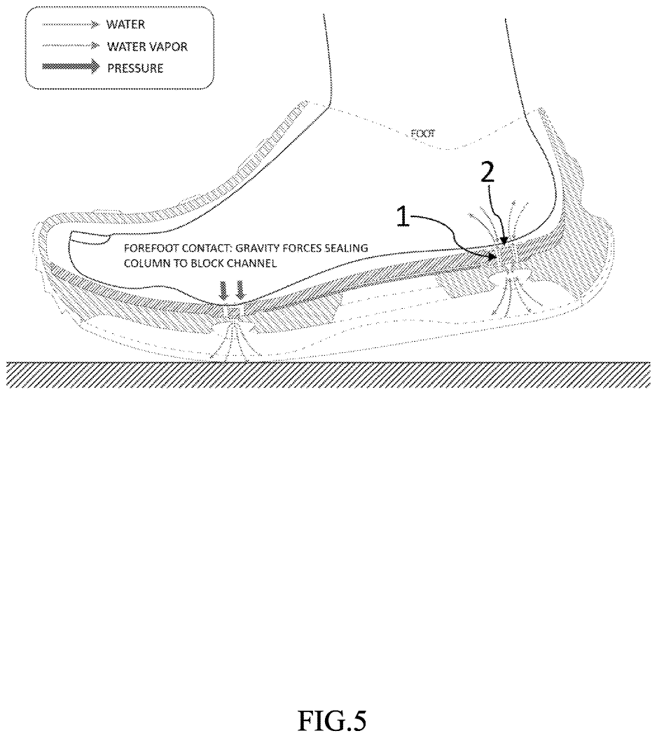

Referring to FIGS. 1 to 5, the present invention provides a dynamic waterproof and breathable shoe sole. The shoe sole mainly comprises an upper elastic midsole layer 6 and a lower wear-resistant outsole layer 7, which are combined by bonding, welding, or other suitable joining methods.

On an upper surface of the elastic midsole layer 6, which is the surface contacting the user's foot, recessed groove structures 3 are formed so as to extend downward. Multiple recessed groove structures 3 are interconnected by water-guiding and air-permeable grooves 5 formed on the same surface, thereby forming a network-like flow-guiding system covering the main forefoot region, as shown in FIG. 1. The depth and width of the water-guiding and air-permeable grooves 5 may be designed as required so as to rapidly guide perspiration moisture generated by the foot.

At a bottom of each recessed groove structure 3, an opening extending to the lower surface of the elastic midsole layer 6 is provided. This opening corresponds to a preset structure in the wear-resistant outsole layer 7.

Within the wear-resistant outsole layer 7, flow-guiding channels 1 are arranged vertically or obliquely. An upper end of each flow-guiding channel 1 forms a first port 101, while a lower end forms a second port 102. The second port 102 expands on the ground-contacting surface of the wear-resistant outsole layer 7 and is connected to a bottom of a funnel structure 701. The funnel structure 701 helps disperse water flow when the shoe is immersed in water, prevents water accumulation, and reduces direct water pressure acting on the second port 102.

Key components of the system include a dynamic sealing column 2 and an end cap structure 4. These two components are assembled as a preassembled unit and installed within the flow-guiding channel system. The end cap structure 4 is made of a highly elastic film or a lightweight polymer foamed material having good elasticity and deformation recovery capability, such as silicone, thermoplastic supercritical polyurethane (TPU), ethylene-vinyl acetate (EVA) and rubber composite high-elastic foamed material (TPR), or polyurethane (PU).

In one embodiment, the size of the end cap structure 4 is matched with the recessed groove structure 3. The edge of the end cap structure 4 is sealingly fixed to the inner wall or bottom surface of the recessed groove structure 3 by a waterproof adhesive or by a hot-press process, thereby sealing the first port 101.

Further, a central portion of the end cap structure 4 is rigidly connected to a top portion of the dynamic sealing column 2 through in-mold overmolding, welding, bonding, or other suitable methods. The dynamic sealing column 2 itself may be made of a relatively rigid material such as rigid TPU or nylon. A bottom portion of the dynamic sealing column 2 is formed with a conical or truncated-cone sealing head 201. A corresponding sealing valve seat 103 is formed on a lower inner portion of the flow-guiding channel 1.

Further, within the end cap structure 4, a plurality of water-guiding and air-guiding holes 401 are evenly distributed around the connection region between the end cap structure 4 and the dynamic sealing column 2, as shown in FIG. 1.

The working principle of the present invention is described below.

In a ventilation state, that is, the first state, as shown in FIGS. 1, 2, 4, and 5, when the user lifts the foot or the pressure applied to the insole is small, the end cap structure 4 made of an elastic material remains flat or slightly convex under its restoring force. In this condition, the end cap structure 4 suspends the dynamic sealing column 2 in the upper portion of the flow-guiding channel 1. The sealing head 201 is separated from the sealing valve seat 103, thereby forming a clear annular breathable gap 104. As indicated by the arrows in the figures, moisture generated inside the shoe is first collected through the network of water-guiding and air-permeable grooves 5 into the recessed groove structures 3. The moisture then enters the space below the first port 101 through the water-guiding and air-guiding holes 401. The moisture subsequently flows smoothly through the breathable gap 104, passes through the flow-guiding channel 1, and is finally discharged to the outside through the second port 102 and the funnel structure 701. Conversely, dry air from the outside may also flow into the shoe through the same path.

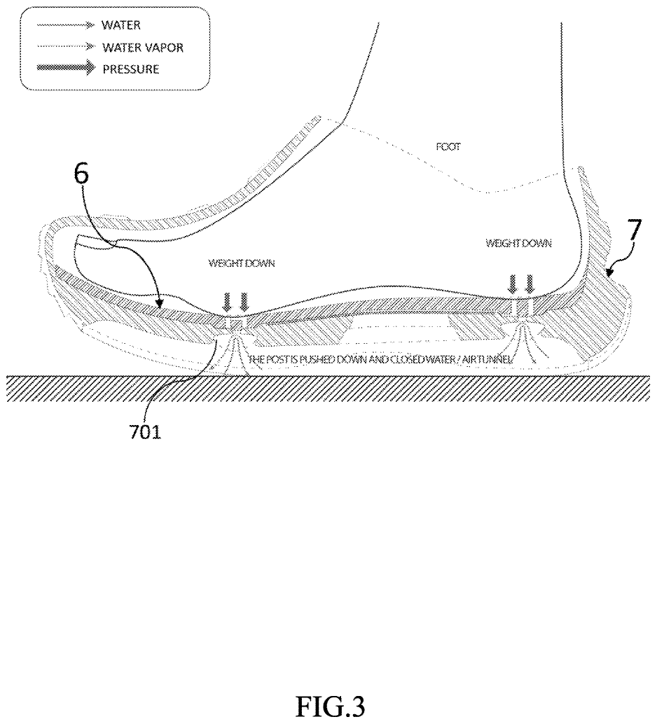

In a waterproof sealing state, that is, the second state, as shown in FIG. 3, when the user's foot presses against the ground, especially when stepping into water, the pressure from the foot directly acts on the end cap structure 4. The end cap structure 4 undergoes elastic deformation and moves downward. Since the dynamic sealing column 2 is fixed to the central portion of the end cap structure 4, the dynamic sealing column 2 is driven downward accordingly. The dynamic sealing column 2 moves downward along the flow-guiding channel 1 until the sealing head 201 at its bottom is tightly pressed into the sealing valve seat 103, thereby forming a reliable circumferential seal and completely blocking the channel. At this time, even if external water reaches the lower portion of the flow-guiding channel 1 through the funnel structure 701 and the second port 102, it cannot pass through the sealed interface. Meanwhile, moisture inside the shoe may still enter the cavity below the first port 101 through the water-guiding and air-guiding holes 401, but cannot be discharged outward. This cavity functions as a temporary air chamber that further prevents external liquid from penetrating into the shoe.

Further, during walking, the user's feet alternately contact the ground, and the flow-guiding channel systems correspondingly cycle between the open state and the sealed state. As a result, continuous ventilation and moisture discharge are achieved macroscopically, while reliable waterproof sealing is ensured locally at each moment of foot contact.

Furthermore, to provide a clearer understanding of the objectives, technical solutions, and advantages of the present invention, the present invention is described in further detail below in conjunction with the accompanying drawings and specific embodiments. However, those skilled in the art should understand that the following embodiments are only intended to illustrate the invention and are not intended to limit its scope.

In the present invention, the involved material performance parameters are all measured according to the following standard test methods:

Foaming ratio: measured by comparing densities before and after foaming using a water displacement method.

Closed-cell rate: measured using a true density analyzer by a nitrogen displacement method.

Shore hardness: measured according to ASTM D2240.

Rebound resilience: measured using the ball rebound method according to ISO 8307.

Compression set: measured according to GB/T 6669 under conditions of 25 percent compression for 22 hours at 23 degrees Celsius.

Tensile strength and elongation at break: measured according to ISO 37.

Tear strength: measured according to ISO 34-1.

### Embodiment 1

This embodiment provides a dynamic waterproof and breathable shoe sole in accordance with the technical solution of the present invention.

### 1. Material Selection and Parameter Control

### Elastic Midsole Layer (6) Material:

Supercritical-foamed TPU. The base material may be commercially available Elastollan 1185A.

Foaming process parameters: saturation temperature 175° C., saturation pressure 18 MPa, saturation time 30 minutes, depressurization rate 12 MPa/s.

### Resulting Material Properties:

density 0.12 g/cm³,
foaming ratio 2.1,
closed-cell rate 93%,
Shore C hardness 38,
rebound resilience 65% (measured by ball rebound method),
compression set 22%.

### Dynamic Sealing Column (2) Body Material:

Rigid TPU, for example commercially available WHT-1195, with Shore D hardness 62.

### Sealing Head (201) Coating Material:

Thermoplastic elastomer with Shore A hardness 70.

### Annular Sealing Member Material:

The same material as the sealing head coating layer.

### Wear-Resistant Outsole Layer (7) Material:

Wear-resistant TPU, such as commercially available Elastollan 1198A, with Shore A hardness 95.

### 2. Structural Dimensional Parameters

Flow-guiding channel (1) first inner diameter D1: 5.0 mm
Dynamic sealing column (2) second outer diameter D2: 4.8 mm

### Breathable Gap (104):

single-side clearance 0.2 mm
Recessed groove structure (3) depth H: 4.5 mm
End cap structure (4) elastic modulus E: 12.5 MPa
Dynamic sealing column mass m: 0.38 g

### Calculation:

$$E \times H = 12.5 \times 4.5 = 56 \text{.25}$$

$$k \times m \times g ( k = 4.0 ) = 4.0 \times 0.38 \times 9.8 = 14.90$$

Thus, the condition

$$E \times H \geq k \times m \times g$$

is satisfied.

### Water-Guiding and Air-Permeable Groove (5):

depth 1.8 mm
width 2.2 mm

### Funnel Structure (701) Opening Angle:

90 degrees

### 3. Manufacturing Process

The preparation process follows the manufacturing method described above.

### Step S1:

Supercritical-fluid foaming is used to prepare the elastic midsole layer. After cutting, the recessed groove structures 3 and water-guiding and air-permeable grooves 5 are obtained.

### Step S2:

Two-shot injection molding is used to manufacture the wear-resistant outsole layer, and the annular sealing member is embedded.

### Step S3:

Secondary injection molding is used to prepare the preassembled component.

The coating thickness of the sealing head surface layer is 0.3 mm.

### Step S4:

The preassembled component is assembled into the elastic midsole layer.

### Step S5:

Hot-press lamination is performed
temperature 90° C.
pressure 0.45 MPa
holding time 45 seconds.

### Embodiment 2

This embodiment is substantially the same as Embodiment 1, except for the following differences.

### Elastic Midsole Layer (6) Material:

Supercritical-foamed PEBAX.

### Foaming Parameters:

saturation temperature 165° C.
saturation pressure 15 MPa
saturation time 25 minutes
depressurization rate 10 MPa/s.

### Resulting Material Properties:

density 0.11 g/cm³
foaming ratio 2.3
closed-cell rate 92%
Shore C hardness 35
rebound resilience 70%
compression set 18%.

### End Cap Structure (4) Elastic Modulus E:

14.2 MPa.

### Dynamic Sealing Column (2) Body Material:

Nylon 12 with Shore D hardness 58.

### Sealing Head (201) Coating Material:

Silicone with Shore A hardness 65.

### Annular Sealing Member Material:

Silicone.

### Embodiment 3

This embodiment is substantially the same as Embodiment 1, except for the following differences.

### Breathable Gap (104) Design Value:

0.15 mm
that is

$$D 1 = 5. mm$$

$$D 2 = 4.85 mm .$$

### Water-Guiding and Air-Permeable Groove (5):

depth 2.2 mm
width 2.5 mm.

During the manufacturing process, the depressurization rate is adjusted to 15 MPa/s in order to obtain a finer microcellular structure.

Comparative Example 1: A static-channel waterproof sole from the prior art is employed, which features irregularly shaped curved channels but does not include a dynamic sealing structure.

Comparative Example 2: An ePTFE waterproof breathable membrane shoe sole according to prior art is used, such as commercially available outdoor waterproof shoes containing a waterproof breathable layer but without a dynamic mechanical structure.

Further, to fully demonstrate the beneficial effects of the present invention, systematic performance tests were conducted on Embodiments 1-3 and Comparative Examples 1-2. All tests were performed in a standard laboratory environment at a temperature of 23±2° C. and a relative humidity of 50±5%.

### Test Method Description:

### 1. Dynamic Waterproof Performance Test

Based on QB/T 2225-1996 “Determination of Dynamic Waterproof Performance of Shoe Sole Materials,” with certain modifications, a self-developed dynamic water resistance tester was utilized:
Test principle: The shoe sole sample is mounted on a simulated foot model and placed in water with a depth of 10 cm. Walking motion is simulated at a step frequency of 60±2 steps per minute. The time at which water first penetrates into the shoe interior is recorded as the water penetration time, and the amount of water ingress after one hour is measured;
Test equipment: A self-developed dynamic walking simulator with adjustable stride, and an electronic balance with a precision of 0.01 g;
Evaluation criteria: Longer penetration time and smaller water ingress indicate better waterproof performance.

### 2. Breathability Performance Test:

Based on GB/T 3903.33-2008 “Test methods for footwear insoles and insocks Water absorption and desorption,” and ISO 22649:2016:
Test principle: Under a constant pressure difference of 500 Pa, the volume of gas passing through a unit area of the shoe sole per unit time is measured;
Test equipment: Air permeability tester, such as Gurley 4340;
Dynamic air permeability test: Real-time monitoring of air permeability changes under dynamic pressure simulating walking stride.

### 3. Dynamic Pumping Moisture Discharge Efficiency Test

Test principle: The shoe sole is connected to a sealed chamber containing a saturated humidity source (relative humidity 98%). Walking motion is simulated, and the rate of humidity reduction within the chamber is measured;
Test equipment: Temperature and humidity data logger with accuracy ±2% RH and dynamic loading device;
Evaluation indicator: Percentage decrease in relative humidity within 30 minutes.

### 4. Dynamic Seal Life Test:

In accordance with the accelerated test method for dynamic seal life:
Test principle: The shoe sole is mounted on a fatigue testing machine and subjected to reciprocating loading at a frequency of 120±5 cycles per minute to simulate reciprocating motion of the sealing column;
Test equipment: Dynamic fatigue testing machine (e.g., INSTRON E3000), leakage detection instrument with accuracy 0.01 mL/min;
Evaluation criteria: Sealing performance is tested every 20,000 cycles by measuring leakage rate until the leakage rate exceeds 0.1 mL/min or the cycle count reaches 200,000 cycles.

### 5. Compression Set Test

Based on GB/T 6669-2008:
Test conditions: 25% compression rate, 22 hours, 23° C.;
Test equipment: Compression set tester and thickness gauge.

Test results are shown in Table below:

| | | | | | |
|---|---|---|---|---|---|
| | | | | Compar- | Compar- |
| | Embodi- | Embodi- | Embodi- | ative | ative |
| Test Item | ment 1 | ment 2 | ment 3 | Example 1 | Example 2 |

Dynamic Waterproof Performance

| | | | | | |
|---|---|---|---|---|---|
| Water penetration time (min) | >120 | >120 | >120 | 38 | 85 |
| Water ingress after 1 hour (g) | 2.3 | 1.8 | 2.1 | 12.5 | 4.2 |

Breathability Performance

| | | | | | |
|---|---|---|---|---|---|
| Static air permeability | 0.52 | 0.58 | 0.48 | 0.15 | 0.31 |
| (L/(cm² · s)) | | | | | |
| Dynamic average air | 0.47 | 0.53 | 0.43 | 0.14 | 0.30 |
| permeability (L/(cm² · s)) | | | | | |

Dynamic Moisture Pumping Efficiency

| | | | | | |
|---|---|---|---|---|---|
| Relative humidity reduction | 42 | 48 | 39 | 12 | 28 |
| in 30 min (% RH) | | | | | |

Dynamic Seal Life

| | | | | | |
|---|---|---|---|---|---|
| Leakage rate after 100,000 | 0.03 | 0.02 | 0.04 | — | — |
| cycles (mL/min) | | | | | |
| Leakage rate after 200,000 | 0.09 | 0.07 | 0.11 | — | — |
| cycles (mL/min) | | | | | |

Material Durability

| | | | | | |
|---|---|---|---|---|---|
| Compression set (%) | 22 | 18 | 23 | — | — |

### Results Analysis

1. Significant advantage in waterproof performance: The water penetration time of Embodiments 1-3 all exceeded 120 minutes, which reached the upper limit of the test duration. The amount of water ingress after one hour was less than 3 g in all cases. These values are significantly better than those of Comparative Example 1 (water penetration after 38 minutes and 12.5 g water ingress) and Comparative Example 2 (water penetration after 85 minutes and 4.2 g water ingress). These results indicate that the dynamic sealing structure of the present invention can effectively prevent external water from entering the shoe under dynamic walking conditions.

2. Substantial improvement in breathability: The static air permeability of Embodiments 1-3 is significantly higher than that of Comparative Examples 1 and 2. The retention rate of dynamic average air permeability exceeds 90 percent, indicating that the sealing column causes almost no obstruction to airflow when in the open state.

3. Pronounced dynamic moisture pumping effect: Embodiments 1-3 reduced the internal chamber humidity by 39-48 percent within 30 minutes, whereas Comparative Example 1 showed only a 12 percent reduction and Comparative Example 2 showed a 28 percent reduction. Embodiment 2 achieved the highest moisture discharge efficiency, which is associated with its higher rebound resilience, thereby verifying the synergistic effect between material selection and the pumping mechanism.

4. Reliability verified by Seal Life testing: After 100,000 dynamic cycles, the leakage rates of Embodiments 1-3 remained below 0.05 mL/min. After 200,000 cycles, the leakage rates remained below 0.12 mL/min. These results demonstrate that the sealing interface design is reasonable and that both wear resistance and elastic performance are well maintained. Embodiment 2 exhibits the optimal life cycle performance, which is associated with its lower compression set.

5. Analysis of the influence of material parameters

A comparison among Embodiments 1-3 shows that:

Embodiment 2 uses a PEBAX material and exhibits the highest dynamic moisture discharge efficiency, confirming that high-resilience materials enhance the pumping effect. Embodiment 3 adopts a smaller breathable gap, resulting in optimal waterproof performance but slightly reduced air permeability, demonstrating the tunability of the design parameters. Embodiment 1 shows balanced overall performance, confirming the rationality of the parameter ranges defined in the present invention.

The technical features described in the above embodiments may be combined in any suitable manner. For the sake of brevity, not all possible combinations of the technical features in the embodiments have been described. However, as long as there is no contradiction among the combinations of these technical features, such combinations should be regarded as falling within the scope of the present description.

The embodiments described above represent only several implementations of the present invention. Although the description is relatively specific and detailed, it should not be interpreted as limiting the scope of the invention. It should be noted that various modifications and improvements may be made by those skilled in the art without departing from the spirit and concept of the present invention, and such modifications and improvements shall fall within the protection scope of the present invention. Therefore, the scope of protection of the present invention shall be defined by the appended claims.

What is claimed is:

1. A dynamic waterproof and breathable shoe sole, comprising a sole body, wherein:
the sole body is provided with at least one flow-guiding channel system therein;
the flow-guiding channel system comprises a flow-guiding channel and a dynamic sealing column;
the flow-guiding channel has a first port in communication with an interior space of a shoe and a second port in communication with an external environment;
the dynamic sealing column is movably disposed within the flow-guiding channel; and
the dynamic sealing column has a first state and a second state, wherein in the first state, a breathable gap is formed between the dynamic sealing column and a wall surface of the flow-guiding channel, and in the second state, the dynamic sealing column forms a sealing engagement with the wall surface of the flow-guiding channel in response to external pressure so as to block passage of liquid.

2. The dynamic waterproof and breathable shoe sole according to claim 1, wherein the flow-guiding channel system further comprises a recessed groove structure, the recessed groove structure being disposed on a surface inside the shoe that contacts a sole of a user's foot and having a concave configuration;
an end cap structure is disposed within the recessed groove structure, the end cap structure sealing the first port; and
a central portion of the end cap structure is fixedly connected to an upper portion of the dynamic sealing column.

3. The dynamic waterproof and breathable shoe sole according to claim 2, wherein:
the end cap structure is made of a supercritical-fluid-foamed thermoplastic polyurethane elastomer or thermoplastic polyester elastomer, having a foaming ratio of 1.8 to 2.5 times, a closed-cell rate greater than 90%, a Shore C hardness of 30 to 45, a rebound resilience greater than 62%, and a compression set of less than 25%;
the dynamic sealing column is made of thermoplastic polyurethane or nylon, having a Shore D hardness of 55 to 65, and a sealing head is formed at a bottom portion thereof, a surface of the sealing head being coated with a thermoplastic elastomer layer having a Shore A hardness of 65 to 75;
the bottom of the flow-guiding channel is provided with a sealing valve seat, wherein an annular sealing member is embedded in the sealing valve seat, the annular sealing member being made of a thermoplastic elastomer that is identical to or compatible with the coating layer on the surface of the sealing head; and
the flow-guiding channel has a first inner diameter D1, the dynamic sealing column has a second outer diameter D2, and a difference between D1 and D2 is between 0.15 mm and 0.35 mm so as to form the breathable gap.

4. The dynamic waterproof and breathable shoe sole according to claim 2, wherein an elastic modulus E of the end cap structure and a depth H of the recessed groove structure satisfy the following relationship:
$$E \times H \geq k \times m \times g ,$$
wherein E represents the elastic modulus of the end cap structure, in MPa; H represents the depth of the recessed groove structure, in mm; m represents a mass of the dynamic sealing column, in g; g represents gravitational acceleration, taken as 9.8 m/s²; and k represents a safety factor having a value ranging from 3.0 to 4.5.

5. The dynamic waterproof and breathable shoe sole according to claim 2, wherein a water-guiding and air-permeable groove is further provided inside the shoe, the water-guiding and air-permeable groove forming a network-like intersecting distribution on an inner sole plane of the shoe, the groove having a depth ranging from 1.0 mm to 2.5 mm and a width ranging from 1.5 mm to 3.0 mm, and being in communication with at least one of the recessed groove structures.

6. The dynamic waterproof and breathable shoe sole according to claim 2, wherein the sole body comprises an upper elastic midsole layer and a lower wear-resistant outsole layer;
the recessed groove structure and the water-guiding and air-permeable groove are formed on an upper surface of or within the elastic midsole layer; and the flow-guiding channel is formed in the wear-resistant outsole layer.

7. The dynamic waterproof and breathable shoe sole according to claim 6, wherein a plurality of funnel structures are further provided on a ground-contacting surface of the wear-resistant outsole layer;
a bottom of each funnel structure respectively corresponds to and communicates with the second port of one of the flow-guiding channels; and
each funnel structure has an opening angle ranging from 60° to 120°.

8. A shoe, comprising the dynamic waterproof and breathable shoe sole according to claim 1.

9. A method for manufacturing a dynamic waterproof and breathable shoe sole, comprising the following steps:
Step S1: preparing an elastic midsole layer using a supercritical fluid foaming process:
placing thermoplastic polyurethane elastomer particles into a foaming mold; after sealing the mold, injecting supercritical carbon dioxide as a physical foaming agent, wherein a saturation temperature is 160-185° C., a saturation pressure is 12-25 MPa, and a saturation time is 20-40 minutes;
subsequently rapidly releasing pressure to atmospheric pressure at a depressurization rate of 8-15 MPa/s to obtain a foamed sheet having a microcellular closed-cell structure;
placing the foamed sheet into a cutting mold and cutting the sheet to form the elastic midsole layer provided with the recessed groove structures and the water-guiding and air-permeable grooves;
Step S2: preparing the wear-resistant outsole layer and sealing assembly using a two-shot injection molding process:
setting a temperature of a first injection unit to 210-230° C., and injecting a wear-resistant thermoplastic material into an outsole mold to simultaneously form the flow-guiding channels (1), the sealing valve seats, and the funnel structures;
after the mold is opened, inserting a prefabricated annular sealing member into the sealing valve seat by a robotic manipulator;
subsequently closing the mold, setting a temperature of a second injection unit to 190-210° C., and injecting a thermoplastic elastomer material to form an integrally bonded structure with the annular sealing member at the sealing valve seat;
Step S3: preparing a pre-assembled component of the dynamic sealing column and the end cap structure:
performing a secondary injection molding process, including first injection-molding a main body of the dynamic sealing column using rigid TPU or nylon as a material, with an injection temperature of 220-240° C.;
then placing the molded dynamic sealing column body into an end-cap mold, overmolding a thermoplastic elastomer layer on a surface of the sealing head, while integrally forming the end cap structure at a top of the dynamic sealing column, wherein the end cap structure is made of supercritical-foaming-grade TPU and an injection temperature is 190-210° C., thereby forming the pre-assembled component;
Step S4: assembly:
installing the pre-assembled component obtained in Step S3 into the recessed groove structure of the elastic midsole layer, applying a waterproof adhesive along an edge of the end cap structure to seal and fix the end cap structure to an inner wall of the recessed groove structure, and inserting the dynamic sealing column into the flow-guiding channel;
Step S5: lamination:
bonding the assembled elastic midsole layer obtained in Step S4 with the wear-resistant outsole layer prepared in Step S2 using a hot-press lamination process, wherein a hot-press temperature is 80-100° C., a pressure is 0.3-0.6 MPa, and a pressure-holding time is 30-60 seconds, thereby completing preparation of the shoe sole.

10. The method for manufacturing the dynamic waterproof and breathable shoe sole according to claim 9, wherein in Step S1, the saturation temperature of the supercritical carbon dioxide is 170-180° C., the saturation pressure is 15-20 MPa, the saturation time is 25-35 minutes, and the depressurization rate is 10-13 MPa/s.
